(19) United States
(12) Patent Application Publication
(10) Pub. No.: US 2010/0050972 A1
(43) Pub. Date: Mar. 4, 2010

(54) Intake System For Motorcycle Engine

(75) Inventors: Marco Cassinelli, Milano (IT); Roberto Tamiazzo, Cuasso Al Monte (Varese) (IT); Stefano Ricotti, Barlassina ( Milano) (IT)

Correspondence Address: Cozen O''Connor, 250 PARK AVENUE, NEW YORK, NY, 10177, US

(73) Assignee: Claudio Castiglioni, Varese (IT)

(21) Appl. No.: 12/526,184

(22) PCT Filed: Jan. 31, 2008
(86) PCT No.: PCT/EP08/51201

§ 371 Date: Sep. 24, 2009

(30) Foreign Application Priority Data
Feb. 8, 2007 (IT) MI2007A000231

(51) Int. Cl. F02M 35/10

(52) U.S. Cl. 123/184.56

(57) ABSTRACT

An intake system for a single or multi-cylinder motorcycle engine comprising one or more cylinders each provided with at least one fuel injector (15), said engine (3) comprising at least one air intake duct (8) and at least one duct (10) for delivering the air towards intake conduits (4) for said cylinders. These latter are not provided with a valving member, said valving member (20) being instead provided in the intake duct (8) of the air box (1), the fuel injectors (15) being disposed above the intake conduits (4) of the corresponding cylinders and being provided downstream of the valving member (20) of the intake duct (8) for the air box (1).

The present invention relates to an intake system for a single or multi-cylinder motorcycle engine in accordance with the introduction to the main claim. An engine is known to comprise one or more cylinders provided with their own intake conduit, in which at least one fuel injector is present. The intake conduits receive air from an air box positioned upstream of the conduits, the air box presenting at least one air intake duct and a conduit for delivering air towards at least one cylinder.

In known motorcycle engines, each intake conduit comprises a throttle valve or butterfly valve, with an injector usually positioned downstream thereof. This means that at high r.p.m. with the throttle valve open, the conduit length available for optimal petrol feed into the air is small. For this reason, high power motorcycle engines comprise in each intake conduit a further injector positioned upstream of the throttle valve to feed the fuel into that conduit, such that at high r.p.m. the feed required to maximize performance is obtained. Hence in these engines, to optimize performance at low load (small throttle valve opening), those injectors downstream of the valve are used, whereas at high load (large throttle valve opening) the injectors upstream of the valve are also used, or these latter alone.

In addition, in known engines provided with injectors upstream of the throttle valve, there is also the problem of hydrocarbons (petrol vapour) being released directly into the atmosphere, due to the fact that because of their position, when the injectors atomize the fuel, a part of it can rise into the air box (upstream of the injectors in the air flow towards the engine intake conduits) and emerge from it into the atmosphere. As this causes known pollution problems, an active carbon filtration system is positioned in the air box or in its connection, so increasing motorcycle costs.

On releasing the accelerator during vehicle usage, it is also known to undergo rear wheel locking with consequent wheel jumping and related steering problems. This is related to the vacuum created in the intake conduits (extremely small volume) on releasing the accelerator, this vacuum resulting in engine braking which therefore transfers to the rear wheel, to lock it.

In engines for automobile use it is known to provide a common air conduit for several cylinder intake conduits, a throttle valve being present in said common conduit. In these engines, the fuel injectors are positioned in the corresponding cylinder intake conduits.

This known solution has as yet found little use in the motorcycle field. This is because, in motorcycles, performance requirements are much higher than in automobiles: such a solution would tend to limit the engine performance itself.

An object of the present invention is to provide an intake system for a motorcycle with a single or multi-cylinder engine which represents an improvement over the corresponding already known motorcycle components.

A particular object of the invention is to provide an intake system for motorcycle engines of the stated type which enables high performance to be achieved at low environmental impact, with very low release of hydrocarbons into the atmosphere.

Another object of the invention is to provide an intake system for motorcycle engines of the stated type which enables better vehicle control to be achieved on releasing the accelerator.

A further object is to provide an intake system for motorcycle engines of the stated type which enables optimal control of the air flow fed to the cylinders to be achieved, resulting in better engine efficiency and contributing to limiting the environmental impact deriving from the use of the motorcycle.

A further object is to provide an intake system for motorcycle engines of the stated type which enables the air flow directed towards its intake conduits to be smoothed, so limiting the formation of air vortices and enabling better cylinder filling.

These and other objects which will be apparent to the expert of the art are attained by an intake system in accordance with the accompanying claims.

The present invention will be more apparent from the accompanying drawings, which are provided by way of non-limiting example and in which:

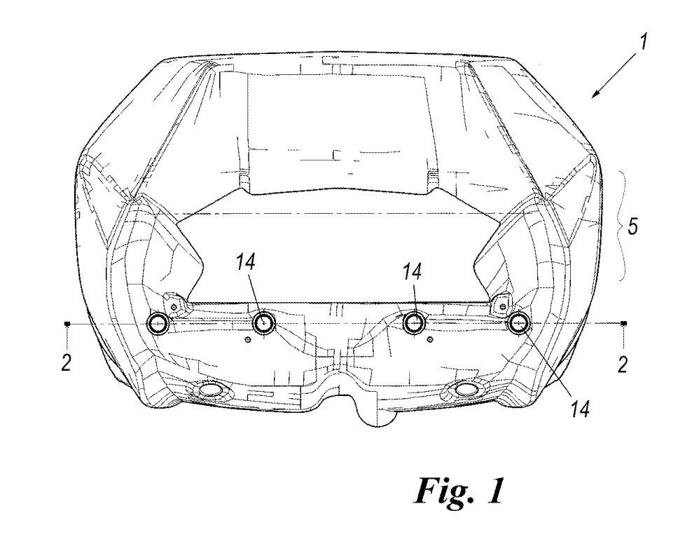

FIG. 1 is a view taken from above showing a part of an intake system for a multi-cylinder engine according to the invention;

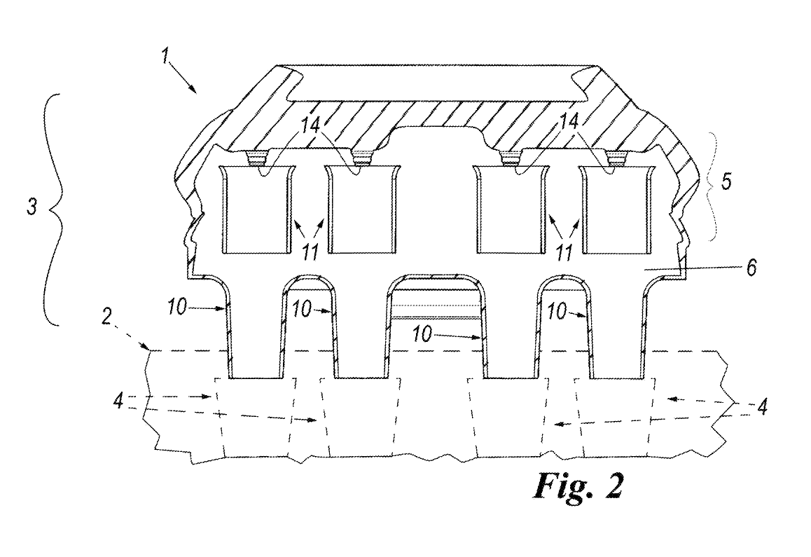

FIG. 2 is a section on the line 2-2 of FIG. 1;

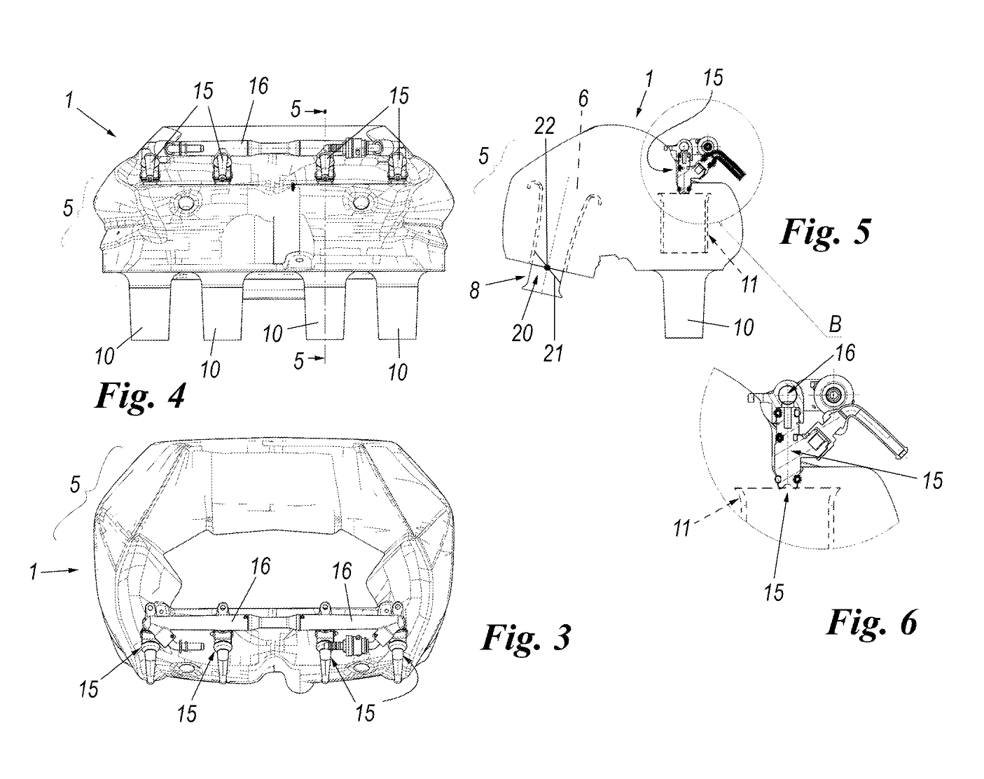

FIG. 3 is a view from above of the part shown in FIG. 1, but without the injectors;

FIG. 4 is a front view of the part shown in FIG. 3;

FIG. 5 is a section on the line 5-5 of FIG. 4;

FIG. 6 is an enlarged view of the detail indicated by B in FIG. 5;

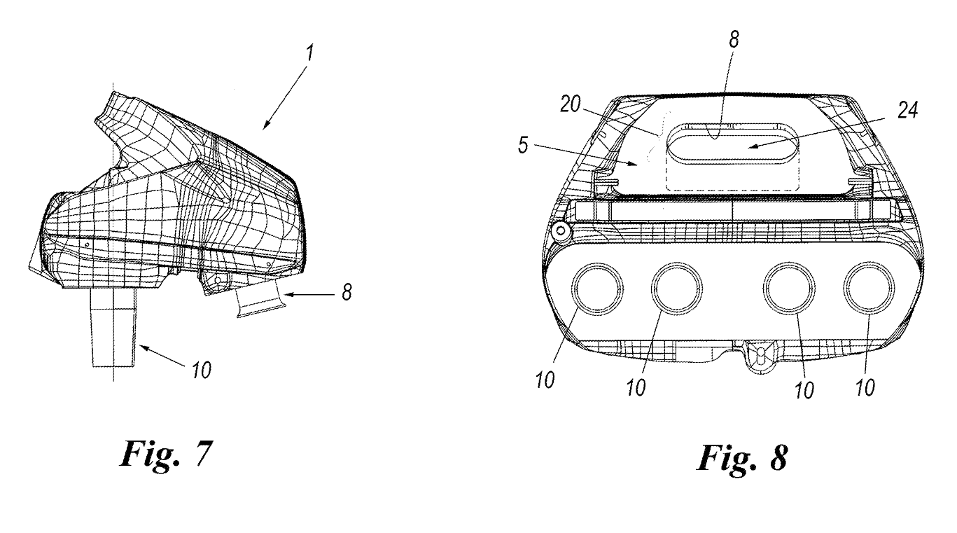

FIG. 7 is a side view of the part shown in FIG. 1;

FIG. 8 is a view from below of the part shown in FIG. 1;

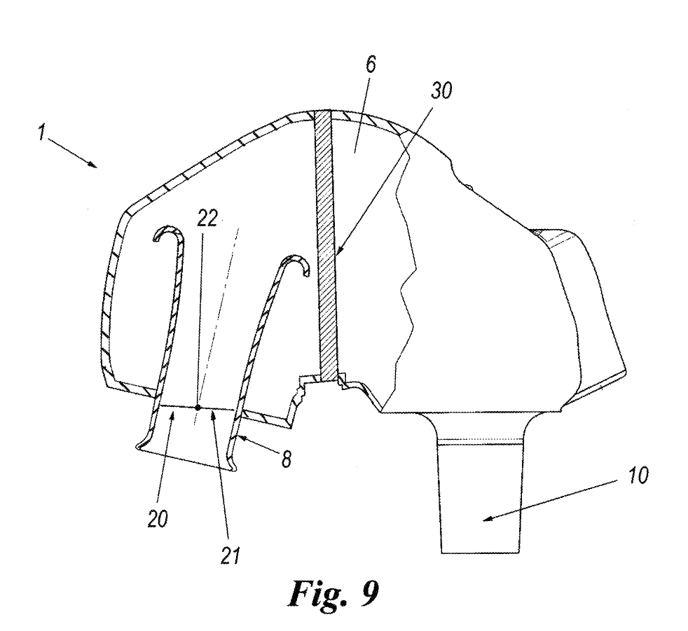

FIG. 9 is a schematic view of a variant of the invention shown in FIG. 1;

Figures from 10 to 17 schematically show various motorcycle engine configurations obtainable using the intake system of the invention.

With reference to said figures, these mainly show an air box 1 mounted on the cylinder head 2 of an engine 3 of which the air box 1 forms part. The cylinder head 2, shown only in FIG. 2 in schematic dashed form, comprises in this case a plurality of cylinders provided with usual intake conduits 4; corresponding pistons move within these cylinders (not shown) of the engine 3. The air box 1 comprises a body 5 defining an inner cavity 6 opening to the outside of this body via an intake duct 8 and connected to delivery conduits 10 disposed above the intake conduits 4 of the engine 3 cylinders and projecting towards them. In one embodiment of the invention, a variable geometry (length/diameter) intake device or system (indicated as parts 11) can be inserted into the cavity 6 at the delivery conduits 10 to direct the air flow entering the air box 1 through the intake duct 8 towards the conduits 10. Said device is of known type and is therefore not further described.

Above each conduit 10 and hence above each intake conduit 4, injectors 15 are present housed in their own seats 14, to inject fuel into said intake conduits 4. These injectors 15 are of known type and are preferably located at a common conduit 16 arranged to transfer the fuel to said injectors, this fuel being withdrawn in known manner from a tank (not shown), to be injected in known manner into the intake conduits 4. Hence each cylinder comprises its own injector.

According to the invention, in contrast to known motorcycle engines, the intake conduits 4 of the engine 3 according to the invention are without the throttle valve for varying their opening; instead, in the intake duct of the air box 1 at least one valving member of any sectional shape is positioned, in particular elliptical (elliptical intake) 20, which can be a butterfly valve 21 movable about a shaft 22 (as shown in FIG. 5, for example) or a slide valve 24, as shown in FIG. 8, or a shut-off valve of any shape and manner of opening (for example of plug, diaphragm etc. type). In all cases, the valving member or members provided within the intake duct 8 of the air box 1 are the only members for adjusting the air flow to the engine intake conduits 4, the air reaching the air box 1 from at least one conduit of known type (not shown in the figures) which usually extends to the front of the motorcycle.

Consequently, according to the invention, the motorcycle engine shown in the figures comprises an air box 1 having an air intake duct 8 provided with a valving member 20 enabling the air flow to the intake conduits 4 of the engine 3 cylinders to be regulated; the air box supports the injectors 15, which are hence disposed downstream of the air box intake duct 8 and downstream of the valving member for the engine flow rate, and hence positioned downstream of the region in which the air enters the interior of the engine 3 in the direction of movement of the air flow. These injectors hence atomize the fuel directly within this flow directed to the underlying cylinders, without the fuel being able to escape from the conduit 8, said fuel hence being able to freely mix with this air and be directed to said cylinders without any further obstruction. This enables the engine capacity to be completely utilized at each r.p.m. and limits hydrocarbon dispersion into the environment.

By virtue of the possible presence of a variable length system 11, the fuel/air mixture can be optimally directed towards the engine cylinder intake conduits 4. The valving member 20 can be driven in any known manner, such as by usual gear arrangements on the shaft 22 of the butterfly valve 21 or by a mechanical drive on the movable slide valve. According to the invention, this drive is preferably in the form of a drive-by-wire arrangement which improves control of the opening of the valving member 22 and also improves engine power delivery, hence limiting the environmental impact if using this latter.

If the valving member 20 is in the form of a slide valve 24, this latter moves transversely to the intake duct 8 of the air box 1. In a preferred embodiment, this conduit is formed from one or more elliptical elongate slots provided within the interior of the body 5 of the air box 1 (see FIG. 8); this embodiment enables said conduit to be completely freed if the engine capacity is to be utilized fully, i.e. for high r.p.m.: in this case, the slide valve 24 is completely displaced to the side of the conduit 8, which is hence in no way reduced. A free air flow can hence be obtained without pressure drops induced by interaction between the air flow at maximum flow rate and the shaft 22 of the butterfly valve within the air box 1 and hence within the intake conduits 4 of the engine cylinders.

Said characteristic is not possible if a usual butterfly valve 21 is provided, such as that shown in FIG. 5, in that even in its maximum open position the valve always intercepts the intake duct 8, even if only slightly, because of its presence therein. Even in currently used motorcycle engines comprising a butterfly valve inserted into the cylinder intake conduits, it is never possible to obtain a free air flow through these latter, as is possible in the case of the present invention.

According to a preferred variant of the invention, a device is present in the air box 1 to regularize the flow of air entering the cylinders. This device comprises a part 30 interposed between the intake duct 8 and the delivery conduits 10, said part 30 being preferably and advantageously formed of an open-cell cellular or otherwise mesh-like structure. The purpose of the part 30 is to regularize and “calm” the air flow within the air box 1 by limiting air vortex formation therein, to hence achieve more uniform filling of the cylinder intake conduits 4.

Preferably, the part 30 is of polymer material, such as open-cell polyurethane, and is interposed between the valving member and the injectors 15. Alternatively, this part can also be an actual mesh element.

By virtue of the flow regularizing device, an air box 1 can be formed with particular shapes and dimensions based on the actual appearance to be given to the motorcycle and/or on the size of the box when on the motorcycle. This is because the part 30 compensates for the creation of any vortices inside the air box, which vortices would be created in its absence and would influence correct, regular and optimal engine operation.

As the cylinder intake conduits 4 are in direct contact with the cavity 6 in the body 5 of the air box 1, this cavity having a volume considerably greater than that of said conduits 4, the invention also enables rear wheel locking to be limited or completely avoided during accelerator release. This is because the cavity 6 disperses the vacuum created in the intake conduits 4 following accelerator release by the motorcycle driver, this considerably reducing or even preventing complete rear wheel locking deriving from said vacuum which, in a very small volume such as that of the intake conduits 4, creates an engine braking effect which leads to said locking. This situation is that which normally arises in known motorcycle engines, a situation which has to be overcome by specific rear wheel anti-jumping devices. With the invention, such anti-jumping devices could also be dispensed with or at least can be simplified in their construction and operation.

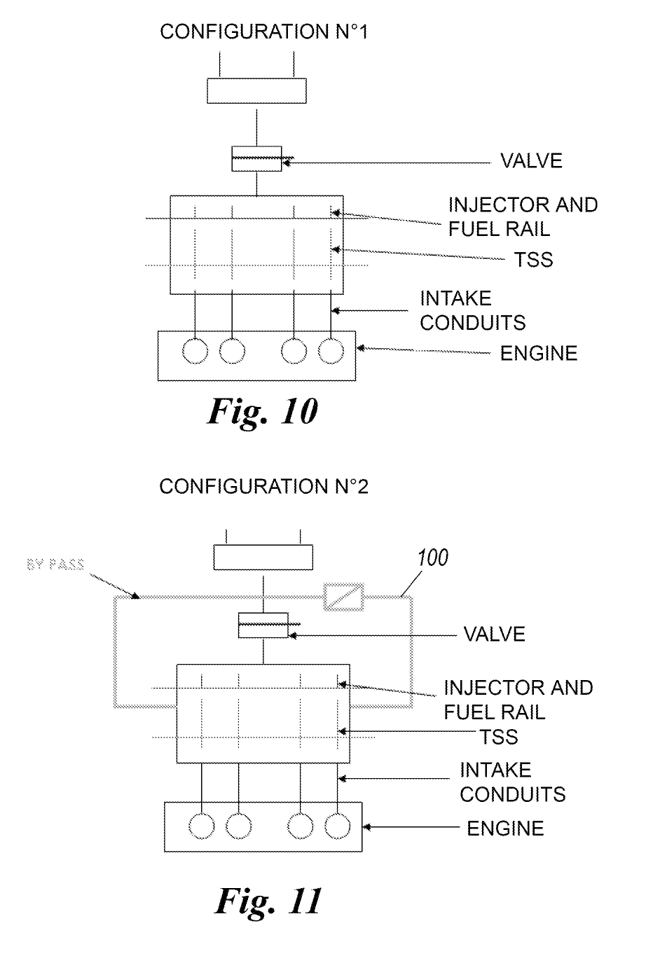

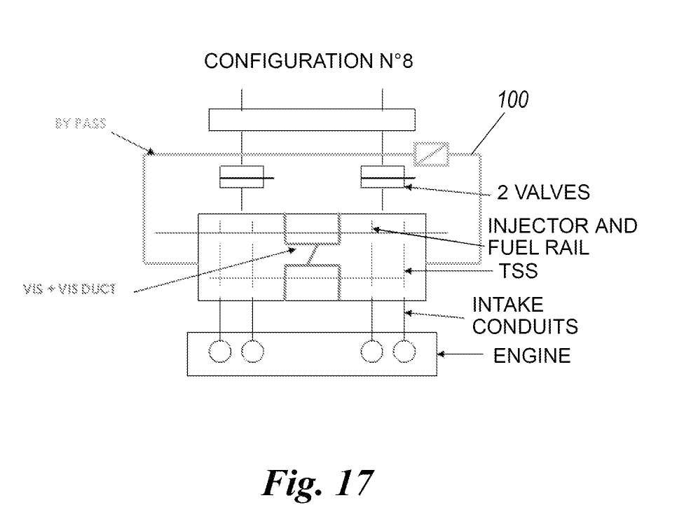

A number of specific embodiments of the invention have been described, however others could be conceived on the basis of the aforegoing, these embodiments differing on the basis of the number and arrangement of the cylinders and the complexity of the devices to be inserted into the body 5 of the air box 1. In particular, these embodiments enable the engine configurations of FIGS. 10 and 17 to be obtained.

The configurations in question, which are already known per se, can comprise:

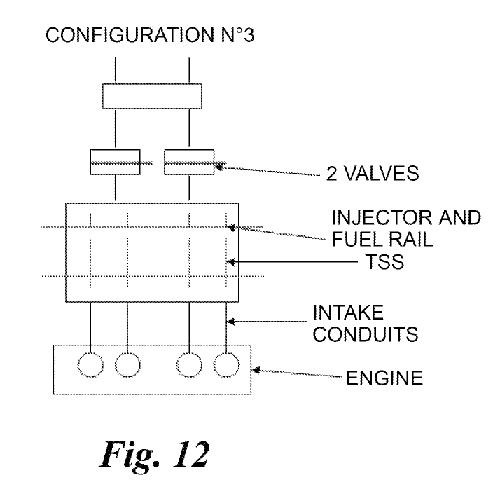

a. a number and type of fluid (air) valving members other than one (see FIG. 12);

b. the presence or absence of a device for geometrically varying (in particular lengthwise) the intake conduits, as in FIGS. 2, 5, 9 and 10;

c. the presence or absence of one or more bypass conduits 100 (FIG. 11);

d. the presence of a system for varying the volume of the cavity 6 (VIS, FIG. 14), i.e. a variable intake system;

e. the presence of a system for varying the volume of the cavity 6 with a resonant conduit between the various volume portions into which the body 5 of the air box 1 is divided (VIS duct, FIG. 16).

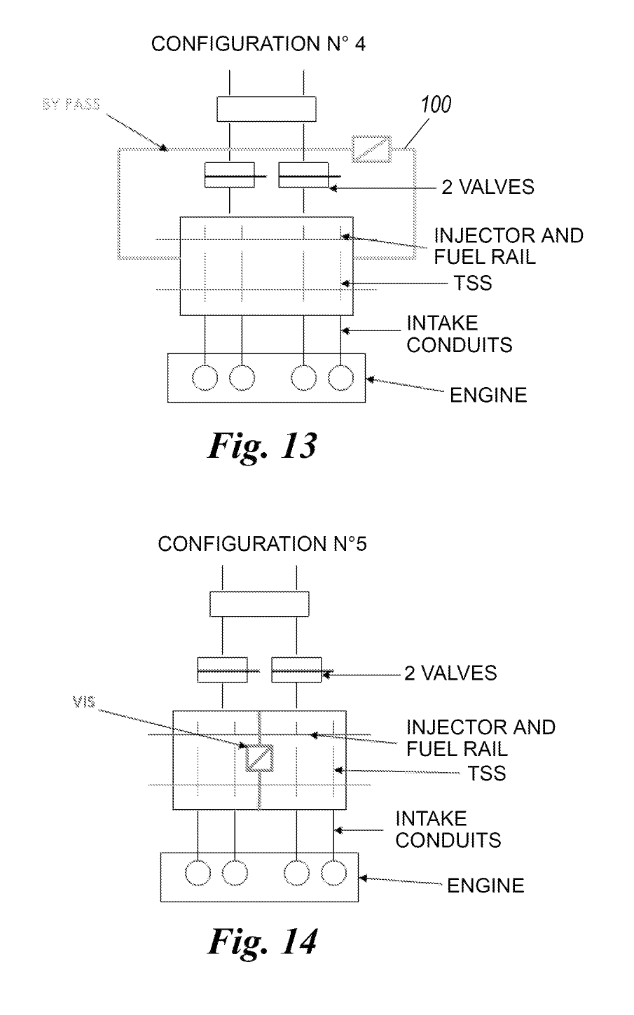

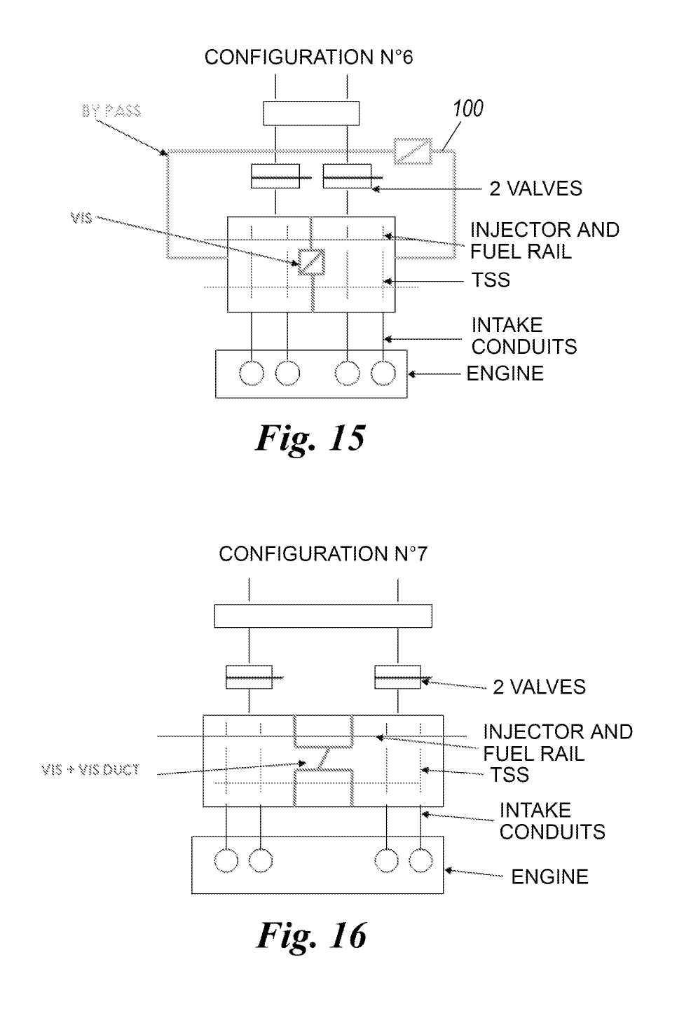

For example, for a four cylinder in-line engine, 8 different configuration variants can be obtained by combining the various aforesaid devices, as shown in Tab. 1 and in FIGS. 10-17.

TABLE 1
List of inventive system configuration variants

| Config- | | | | | | VIS |
|---|---|---|---|---|---|---|
| uration | VALVES | Valve type | TSS | Bypass | VIS | Duct |
| 1 | 1 (or any other | Slide valve | Yes | No | no | No |
| | odd number) | | | | | |
| 2 | 1 (or any other | Slide valve | Yes | Yes | no | No |
| | odd number) | | | | | |
| 3 | 2 (or any other | Slide valve | Yes | no | no | No |
| | even number) | | | | | |
| 4 | 2 (or any other | Slide valve | Yes | Yes | no | No |
| | even number) | | | | | |
| 5 | 2 (or any other | Slide valve | Yes | no | Yes | No |
| | even number) | | | | | |
| 6 | 2 (or any other | Slide valve | Yes | Yes | Yes | No |
| | even number) | | | | | |
| 7 | 2 (or any other | Slide valve | Yes | no | Yes | Yes |
| | even number) | | | | | |
| 8 | 2 (or any other | Slide valve | Yes | Yes | Yes | Yes |
| | even number) | | | | | |

These solutions are also to be considered as falling within the scope of the present invention as defined by the following claims.

1. An intake system for a single or multi-cylinder motorcycle engine comprising one or more cylinders each provided with at least one fuel injector (15), said engine (3) comprising at least one air intake duct (8) and at least one duct (10) for delivering the air towards intake conduits (4) for said cylinders, characterised in that these latter are not provided with a valving member, at least one valving member (20) being instead provided in the intake duct (8) of the air box (1), the fuel injectors (15) being disposed above the intake conduits (4) of the corresponding cylinders and being provided downstream of the valving member (20) of the intake duct (8) for the air box (1).

2. An intake system as claimed in claim 1, characterised in that the valving member (20) is a butterfly valve (21) provided with its own shaft (22) located within said intake duct (8) of the air box (1).

3. An intake system as claimed in claim 1, characterised in that the valving member is a plug valve.

4. An intake system as claimed in claim 1, characterised in that the valving member is a slide valve (24).

5. An intake system as claimed in claim 4, characterised in that the slide valve (24) assumes a working position in which the air box intake duct (8) is completely uncovered.

6. An intake system as claimed in claim 1, characterised in that the fuel injectors (15) are supported by the air box (1).

7. An intake system as claimed in claim 1, characterised in that the air box (1) comprises a hollow (at 6) body (5) mounted on the usual engine head (2) in which the engine cylinder intake conduits (4) are provided.

8. An intake system as claimed in claim 7, characterised in that said body presents a plurality of delivery conduits (10) projecting towards the respective cylinder intake conduits (4).

9. An intake system as claimed in claim 7, characterised in that the cavity (6) of the body (5) of the air box (1) is divided into a plurality of volumes connected or connectable together via shut-off valves, these latter being of any known type.

10. An intake system as claimed in claim 9, characterised in that the plurality of volumes into which the cavity (6) of the body (5) is divided is connected or connectable to the body (5) via external conduits, these conduits being restrictable by shut-off valves, these latter being of any known type.

11. An intake system as claimed in claim 9 or 10, characterised in that the cavity (6) contains a device for varying the geometry of the intake conduits.

12. An intake system as claimed in claim 1, characterised in that the valving member (20) is driven by a “drive-by-wire” connection.

13. An intake system as claimed in claims 1 and 7, characterised in that inside the air box (1) a part (30) is provided, interposed between the intake duct (8) and each delivery conduit (10) of said air box, to smooth the air flow transiting between the duct and conduits.

14. An intake system as claimed in claim 13, characterised in that said part (30) presents an open-cell cellular structure.

15. An intake system as claimed in claim 13, characterised in that said part (30) is of open-cell polymer material.

16. An intake system as claimed in claim 13, characterised in that said part (30) is of mesh form.

17. An intake system as claimed in claim 13, characterised in that said part (30) is interposed between the valving member (20) and the fuel injectors (15).
